(19) United States
(12) Patent Application Publication
(10) Pub. No.: US 2003/0209385 A1
(43) Pub. Date: Nov. 13, 2003

(54) Ladder-cart

(76) Inventors: Gerald E. Kuehl, Collegeville, PA (US); Ronald Bernard, Coatesville, PA (US); William F. Frame, Hochessin, DE (US)

Correspondence Address: Richard P. Gilly, Wolf, Block, Schorr and Solis-Cohen LLP, 22nd Floor, 1650 Arch Street, Philadelphia, PA, 19103, US

(21) Appl. No.: 10/431,781

(22) Filed: May 8, 2003

Related U.S. Application Data
(60) Provisional application No. 60/378,590, filed on May 8, 2002.

(51) Int. Cl. E06C 1/00

(52) U.S. Cl. 182/17

(57) ABSTRACT

A ladder-cart for transporting materials has a storage portion with a substantially horizontal area for placing the materials theron. It has a frame having a plurality of support members connected to the storage portion to secure the storage portion above ground level. A plurality of wheels are attached to the frame for engaging the ground and a ladder portion comprising a plurality of steps is integral with the frame.

### CROSS-REFERENCE TO RELATED APPLICATION

This application claims the benefit of U.S. Provisional Application No. 60/378,590, filed May 8, 2002, the entire disclosure of which is incorporated herein by reference.

### FIELD OF THE INVENTION

The present invention is directed to a combination ladder and cart. More particularly, the present invention is directed to a structural combination that allows for simultaneous transport of materials and access to heights above ground level reach.

### BACKGROUND OF THE INVENTION

Often, materials in factories, warehouses, stores, or other storage facilities are stored on shelving or storage structures above ground level reach; this allows for more efficient use of space. It is likewise often necessary to move materials in and around these various facilities. In these various situations, a ladder-type apparatus is often desirable to place and retrieve those materials above ground level reach, and a cart or hand truck generally may prove useful either for horizontal transport or for assisting during use of the ladder.

In some cases, hand trucks that transport materials have attachments for carrying ladders. These ladders are used separately from the hand truck in placing transported items on shelves or otherwise above ground level reach.

In other instances, a typical cart has rungs or a rung ladder attached to one side of the cart, or a “fold out” ladder which requires adjustment to use the ladder. Materials can be transported on such a cart; however, such carts are generally poorly suited for functioning as a ladder. In certain variations of these carts, the ladder's legs are adjustable such that when the ladder is in use, the legs engage the ground; when the cart is in use, the legs of the ladder disengage the ground, thus disabling use of the ladder. This design likewise suffers from various encumbrances and drawbacks. For example, when a user climbs the ladder and then steps off the ladder above ground level, the legs of the ladder disengage from the ground and render the cart unstable.

Certain types of retractable or collapsible ladders can be wheeled in their retracted/collapsed state and may even be able to transport other items; however, such ladders are ill-suited to function as carts. For example, the retracted/collapsed portions must be restored to use the ladder. Also, in certain storage facilities, ladders are not well-suited for accessing storage sites above ground level reach because of the structural features of the sites, e.g., floors constructed of bar grating and mezzanines.

Thus, there is a need for a device which functions more optimally as both a ladder and cart.

### SUMMARY OF THE INVENTION

In-accordance with one aspect of the present invention, a ladder-cart for transporting materials is disclosed. The ladder-cart has a storage portion with a substantially horizontal area for placing the materials theron. It also has a frame having a plurality of support members connected to the storage portion to secure the storage portion above ground level. A plurality of wheels are attached to the frame for engaging the ground and a ladder portion comprising a plurality of steps is integral with the frame.

In accordance with another aspect of the present invention, the frame of the ladder-cart defines a perimeter and the ladder portion and the storage portion are contained substantially within the perimeter.

### BRIEF DESCRIPTION OF THE DRAWINGS

In the drawings, which are discussed below, one or more preferred embodiments are illustrated, with the same reference numerals referring to the same pieces of the invention throughout the drawings. It is understood that the invention is not limited to the preferred embodiments depicted in the drawings herein, but rather it is defined by the claims appended hereto and equivalent structures.

FIG. 1 is a perspective view of one embodiment of the ladder-cart of the present invention.

FIG. 2 is a side view of the embodiment of FIG. 1.

FIG. 3 is a side view of a second embodiment of the ladder-cart of the present invention.

FIG. 4 is a perspective view of a third embodiment of the ladder-cart of the present invention.

FIG. 5 is a side view of the embodiment of FIG. 4.

FIG. 6 is a side view of a fourth embodiment of the ladder-cart of the present invention.

### DESCRIPTION OF THE INVENTION

While the specification concludes with claims particularly pointing out and distinctly claiming the subject matter that is regarded as the invention, the invention will now be further described by reference to the following detailed description of preferred embodiments taken in conjunction with the above-described accompanying drawings.

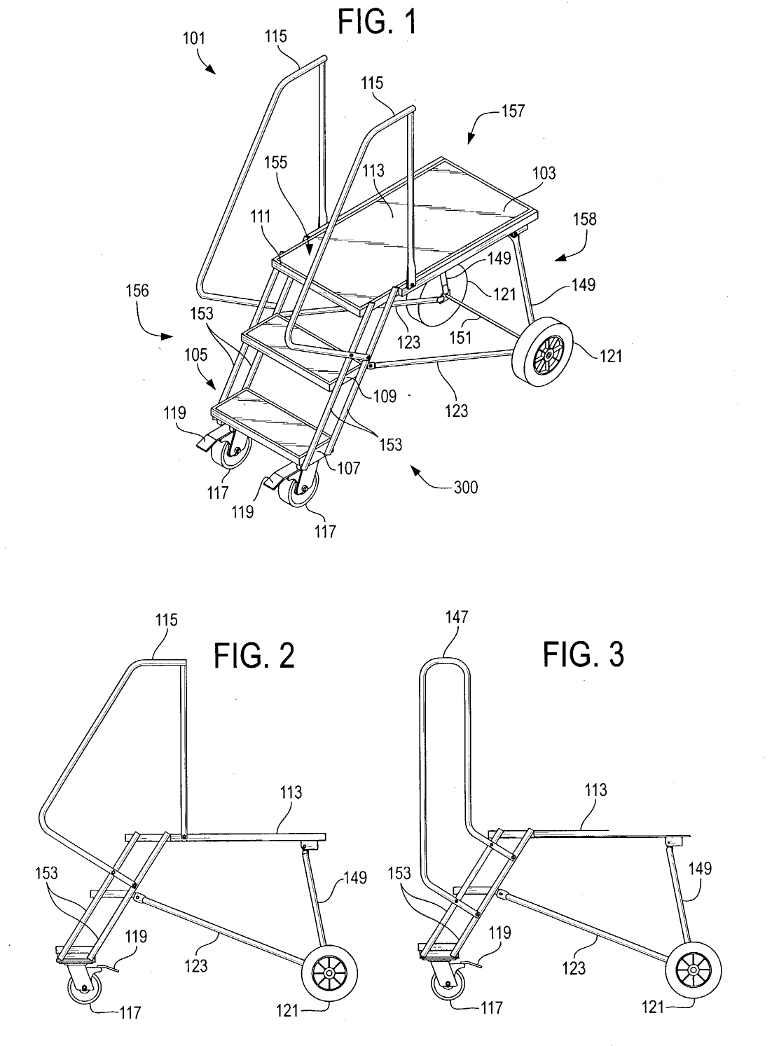

Referring to the embodiment shown in FIGS. 1-2 (and its variation shown in FIG. 3), a ladder-cart 101 has a frame 300, integral steps 107, 109, 111 and a storage portion 103. The storage portion 103 preferably includes a substantially horizontal surface within reach of a user situated on or near the ladder portion 105. In this way, the horizontal surface functions as a storage or loading platform 113 for materials being transported or otherwise handled in conjunction with the ladder cart. Frame 300 generally secures the storage portion 103 at a suitable location relative to the ground and relative to the ladder portion 105. A user can roll the ladder-cart 101 to a desired location, stop the ladder-cart 101, climb up the ladder portion 105, without having to alter the physical structure of the ladder-cart, and access the storage portion 103 as needed.

The frame 300 preferably includes sufficient, elongated support members, so that ladder-cart 101 is robust enough for its intended environment. This includes not only having sufficient load capacity, but also being sturdy and strong enough to transport items through the environment without excessive vibration or shaking of the frame 300. In the illustrated embodiment, frame 300 includes support members 153 secured at opposite ends of storage portion 103 and extending downwardly to oppose the ground, as well as a pair of struts 123 interconnecting corresponding pairs of support members 153. A further support member 153 in the form of a transverse piece 151 interconnects opposite sides of frame 300. Wheels 117, 121 are connected to the lower portion of frame 300 at suitable locations to engage the ground, preferably at or near the four “corners” of the lower portion of the frame 300. The frame 300 has a front end 156 corresponding to front end 155 of the storage portion 103 and a rear end 158 corresponding to rear end 157 of the storage portion 103.

The ladder-portion 105 is located on one end of frame 300, preferably the front end. Ladder portion 105 is integral with frame 300. By “integral,” it is meant that at least a portion of the structures required to form a ladder likewise serves as the frame of the ladder-cart as a whole. Thus, in this preferred embodiment, the support pieces 153 at the front end 156 forming part of frame 300 likewise serve as stringers to support steps 107, 109, 111 at the appropriate locations to form part of ladder portion 105. Ladder portion 105 is substantially fixed relative to frame 300.

Ladder portion 105 includes sufficient steps for its intended application. In this embodiment, three steps 107, 109, 111 are included, although other preferred embodiments include between two and seven steps. Still more steps can be used in a ladder-cart with a similar structure modified as necessary to accommodate the additional steps. The steps 107, 109, 111 are interconnected in series by stringers or support pieces 153. The top step 111 is substantially level with and integrated into the loading platform 113. Thus, the front end 155 of the loading platform 113 is supported by support pieces 153.

Preferably, the ladder portion 105 is positioned at a slope so that the steps of the ladder portion are stairway-like to increase the ease of use of the steps. One suitable range of slopes is between about 50° and about 57°. This slope generally allows for improved ergonomics for the users, including a more secure sense of balance when handling loads or otherwise conducting operations in connection with the ladder-cart. For example, a user is able to stand on and work from the ladder portion 105 without having to lean forward to maintain his or her balance.

To increase safety, the steps 107, 109, 111 of the ladder portion optionally have materials that provide texture and increase their frictional coefficient, thus reducing risks of a user slipping. For example, a sand paper-like substance can be placed on the top surface of the steps or the top surface of the steps can be grooved, have ridges, use runners, or be rough so that the surface of the steps is textured. The perimeter of the frame 300 is defined by the lead edge of the base of the ladder portion 105 and the back edge of the support pieces 149 located opposite the ladder portion 105. Preferably, the storage portion 103 and integral ladder portion 105 are both contained substantially within the perimeter of the frame 300.

Optional handrails 115 are secured to at least one of the support members 153 on both sides of the ladder portion 105. Handrails 115 have portions located at a sufficient height above ladder portion 105 so that a user can grip such handrail portions when using the ladder portion 105. As shown in FIGS. 1 and 2, each of the handrails 115 is oriented in a diagonal direction, i.e., substantially parallel to the direction of the rise of the steps 107, 109, 111. In an alternative embodiment, shown in FIG. 3, the handrails 147 are positioned in a largely vertical direction.

To improve the structural rigidity and stability of the ladder-cart 101, struts 123 are diagonally positioned and located between the wheels 121 and ladder portion 105. Additionally, the rear wheels 121 are connected to each other by support 151, which optionally serves as an axle.

The two pairs of wheels 117, 121, respectfully, engage the ground and are attached to the front 156 and rear 158 of the frame 300. The front pair of wheels 117 is connected to the ladder-cart 101 through attachment to the base of the ladder portion 105. The rear pair of wheels 121 is connected to the storage portion 103 by support members 153 in the form of support rods 149. At least one pair of wheels 117 pivot. In this embodiment, the front wheels 117 are smaller than the rear wheels 121. Although other relative sizes are equally suitable depending on the intended application or work environment. For example, the wheels 117, 121 can all be the same size. Additionally, the rear wheels 121 are connected to each other by support member 151, which optionally serves as an axle.

Although not required to prevent the ladder-cart from unintentionally rolling, a suitable stopping mechanism, such as indicated by reference number 119, can be operatively associated with one or more wheels 117, 121. Stopping mechanism 119, also referred to as a locking mechanism, brake, etc., is foot-activated in this embodiment. A tongue or lever is rotatably mounted in operative proximity to a corresponding pair of wheels 117 and extends outwardly so that a user may selectively access the tongue. In a manner known to the art when the user rotates the extending portion of the lever, a rear portion of the level engages the wheel surface to secure it against rotation.

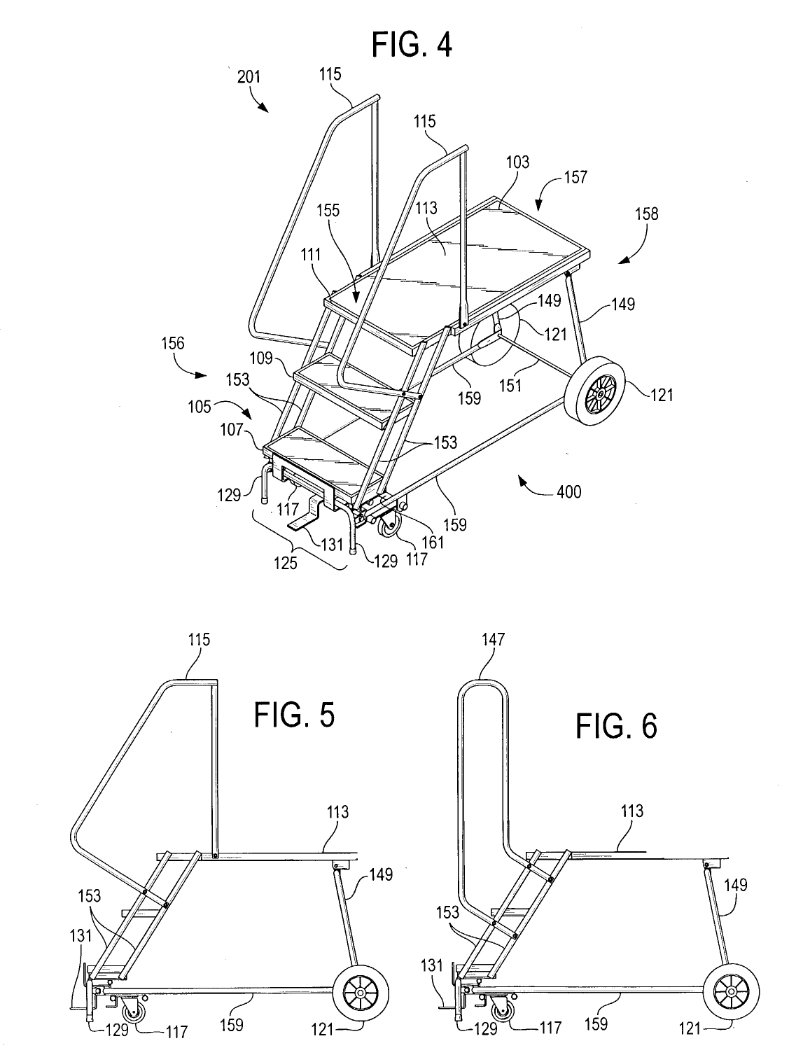

Another embodiment of the ladder-cart is shown in FIGS. 4 and 5 (and its variation shown in FIG. 6). Similar to the embodiment shown in FIGS. 1-3, the frame 400 includes ladder portion 105 and support members 153. In this embodiment, however, the struts 159, rather than extending diagonally as with struts 123 in FIGS. 1-3, extend substantially horizontally between the wheels 121 and ladder portion 105. The struts 159 are connected between corresponding pairs of support members 153.

Ladder-cart 201 has been provided with a stopping mechanism 125 in the form of a so-called LOCK-STEP device. In this illustrated embodiment, the stopping mechanism 125 includes two legs 129 secured to the front of the ladder-cart 201 so as to be moveable relative to the floor or ground surface on which the ladder-cart 201 is placed. The legs 129 engage and disengage the ground through use of a pedal 131 in a known manner.

The wheels 1 17 utilized in the above-described embodiments are preferably castors, whereas the wheels 121 preferably comprise inflatable or non-inflatable rubber tires. Other types of wheels and tires are likewise suitable, depending on the environment, and are generally chosen so as to provide suitable stability and mobility. Preferably, the rear wheels are larger than the front wheels; more preferably, the rear wheels are 10″ in diameter and the front wheels are 4″ or 6″ in diameter; even more preferably, the front wheels are 2″×6″ (meaning 2″ wide and 6″ in diameter), which is well-suited for rolling over bar grating or other uneven surfaces.

Preferably, the ladder-cart of the present invention is substantially constructed of steel, aluminum, fiberglass, plastic, alloys or combinations of these materials. Other materials known to the art are likewise suitable, so long as the resulting structure meets the requirements of its likely uses. Frame 300 is preferably formed from elongated members, including tubular pieces, bar metals, solid rods, beams, and hollow pieces, suitably welded at opposing ends. The materials utilized should preferably be tubing. Numerous dimensions and shapes can be used for the struts and support pieces. Preferably, the struts and support pieces have the following dimensions: 1″ by 0.065 wall thickness, tubing square and/or round. The ladder-cart has a load-bearing capacity of 1200 pounds. The length, width and height of the ladder-cart is determined to a certain extent by the environment it is likely to be used in. For example, for average or low ceilings and tight aisles, a three-step configuration such as that of the preferred embodiments of FIGS. 1-6 is generally suitable, with a width of about 24″, and a length that permits ease of maneuverability.

It will be appreciated that variations to the illustrated embodiments are likewise within the scope of the invention. For example, instead of having four wheels, any number of wheels can be utilized and positioned at a predetermined location(s). The sizes of the wheels can also be varied.

Stopping mechanisms other than those shown at 119, 125 are suitable to prevent the ladder-cart from unintentionally rolling.

Although storage portion 103 has been shown as comprising a planar loading platform 113, other configurations are likewise suitable. In addition, instead of having a single storage portion, the ladder-cart alternatively includes a plurality of storage portions. For example, a first storage portion is located at the top of the ladder cart either as depicted in the figures or above or below the highest step, and one or more additional storage portions are located at other positions on the ladder-cart. One such position for an additional storage portion is below storage portion 113 shown in FIGS. 1-6.

Having described the features and structures of ladder-cart 101, 201, its use and operation will be readily appreciated. A user can push or pull the cart in any suitable manner, including by either grasping the handrails or the ladder portion. Upon reaching a desired location, the user activates the stopping mechanism, if desired, in advance of conducting any of a variety of operations in connection with the ladder-cart. Neither the ladder portion 105 nor the frame 300, 400 is adjusted when activating the stopping mechanism. Once stabilized, one possible alternative is for the user to climb up the steps of the ladder portion 105, either with or without materials. The user may hold onto the handrails for support. Once the user has climbed the steps 107, 109, 111, the user is able to perform any number of activities that may be required from the higher vantage point afforded by the ladder-cart. If the platform 1 13 is unencumbered by material, the user may not only use the steps to perform activities from a higher vantage point, but may also stand on platform 113 which is also the top step 1 11 as may be required. Activities including retrieving, storing, transporting, reorganizing, rotating, or any of the countless operations involved in handling stock, items, boxes, etc., which may be above ground level reach. If the user takes an item off of a shelf above ground level, for example, the item can be readily placed on the storage portion 103, since it is adjacent to ladder portion 105. The reverse operation of placing an item from storage area 103 to a location above ground level reach is also readily performed. The stock can likewise be retrieved or stored by the user bringing it directly down or up the ladder, as the case may be. Upon completion of activities at one location, a user may release the stopping mechanism 119, 125, if activated, so as to roll the ladder-cart 105 to another destination.

The present invention may be embodied in other specific forms without departing from the spirit or essential attributes thereof and, accordingly, reference should be made to the appended claims, rather than to the foregoing specification, as indicating the scope of the invention.

We claim:

1. A ladder-cart for transporting materials comprising:
a storage portion with a substantially horizontal area for placing the materials thereon;
a frame having a plurality of support members connected to the storage portion to secure the storage portion above ground level;
a plurality of wheels attached to the frame for engaging the ground; and
a ladder portion integral with the frame, the ladder portion comprising a plurality of steps.

2. The ladder-cart of claim 1, wherein the ladder portion is substantially fixed in relation to the frame.

3. The ladder-cart of claim 1, wherein the frame defines a perimeter and wherein the ladder portion and the storage portion are contained substantially within the perimeter.

4. The ladder-cart of claim 1, further comprising a handrail secured in proximity to the ladder portion.

5. The ladder-cart of claim 1, further comprising a stopping mechanism for preventing the ladder-cart from rolling.

6. The ladder-cart of claim 1, wherein the frame defines a front end and a rear end, and wherein the support members comprise at least one strut extending between the front end and the rear end.

7. The ladder-cart of claim 6, wherein the strut is diagonally positioned.

8. The ladder-cart of claim 1, wherein the ladder-cart is substantially made of at least one of the group consisting of steel, aluminum, fiberglass, plastic, alloys, and combinations thereof.

9. The ladder-cart of claim 1, wherein the steps of the ladder portion include textured surfaces, runners, grooves, or ridges.

10. The ladder-cart of claim 1, wherein the ladder portion is positioned at a predetermined slope.

11. The ladder-cart of claim 10, wherein the predetermined slope preferably ranges from about 50° to about 57°.

12. The ladder-cart of claim 1, wherein at least one of the steps is integrated into the storage portion.

13. A ladder-cart for transporting materials comprising:
a storage portion with a substantially horizontal area for placing the materials thereon;
a frame having a plurality of support members connected to the storage portion to secure the storage portion above ground level, wherein the frame defines a perimeter;
a plurality of wheels attached to the frame for engaging the ground; and
a ladder portion substantially fixed in relation to the frame, the ladder portion comprising a plurality of steps, wherein the ladder portion and the storage portion are contained substantially within the perimeter.

14. The ladder-cart of claim 13, wherein the ladder portion is integral with the frame.

15. The ladder-cart of claim 13, further comprising a handrail secured in proximity to the ladder portion.

16. The ladder-cart of claim 13, further comprising a stopping mechanism for preventing the ladder-cart from rolling.

17. The ladder-cart of claim 13, wherein the frame defines a front end and a rear end, and wherein the support members comprise at least one strut extending between the front end and the rear end.

18. The ladder-cart of claim 17, wherein the strut is diagonally positioned.

19. The ladder-cart of claim 13, wherein the ladder-cart is substantially made of at least one of the group consisting of steel, aluminum, fiberglass, plastic, alloys, and combinations thereof.

20. The ladder-cart of claim 13, wherein the steps of the ladder portion include textured surfaces, runners, grooves, or ridges.

21. The ladder-cart of claim 13, wherein the ladder portion is positioned at a predetermined slope.

22. The ladder-cart of claim 21, wherein the predetermined slope preferably ranges from about 50° to about 57°.

23. The ladder-cart of claim 13, wherein at least one of the steps is integrated into the storage portion.
